(19) United States
(12) Patent Application Publication
(10) Pub. No.: US 2006/0057344 A1
(43) Pub. Date: Mar. 16, 2006

(54) Anti-glare film

(75) Inventors: Seiichi Sakurai, Shizuoka-shi (JP); Kensaku Higashi, Shizuoka-shi (JP)

Correspondence Address: OLIFF & BERRIDGE, PLC, P.O. BOX 19928, ALEXANDRIA, VA, 22320, US

(73) Assignee: TOMOEGAWA PAPER CO., LTD., Tokyo (JP)

(21) Appl. No.: 11/219,661

(22) Filed: Sep. 7, 2005

(30) Foreign Application Priority Data
Sep. 9, 2004 (JP) 2004-261750

(51) Int. Cl. B32B 7/02

(52) U.S. Cl. 428/212

(57) ABSTRACT

An anti-glare film with no color alone is provided, and it is applied to a display by combining with a back light or liquid crystal cell, so that unnecessary coloring is avoided and superior coloring development properties are exhibited. In an anti-glare film having a transparent substrate and an anti-glare layer provided on at least one surface of the transparent substrate, the anti-glare layer is formed by transparent resin which disperses at least two kinds of resin fine particles, and when a layer is formed by transparent resin which disperses each kind of the resin fine particles alone and light transmittance spectrum in a visible light region of the layer is measured, each of the light transmittance spectra is different.

### FIELD OF THE INVENTION

The present invention relates to an anti-glare film which is used by adhering it to the surface of various displays, and in particular, relates to an anti-glare film which is not colored alone and exhibits superior coloring development properties in a liquid crystal display.

### BACKGROUND ART

Displays typified by liquid crystal displays, plasma displays, CRTs, and ELs are widely used in various fields such as television and computer technologies, and they have been developed rapidly. In particular, the liquid crystal displays are in remarkably common use in thin type televisions, portable telephones, personal computers, digital cameras, PDAs, other various devices, etc., as displays which are thin, light, and extremely versatile.

In the case in which the display is used in lighted conditions, such as outdoors, under fluorescent light, etc., there is problem in that external light such as sunlight, fluorescent light, etc., is reflected on the surface of the display, and in order to prevent problems, generally, an anti-glare treatment is performed in which reflection of the external light is diffused by forming irregularities on the surface of the display.

The anti-glare treatment is carried out by forming an irregular surface on the surface material of the display using a sandblasting method, etc., by form-transferring on the transparent resin layer using a form-transferring film or roll with irregularities, by applying a coating material which disperses inorganic or organic transparent fine particles in transparent resin, so that an anti-glare layer is provided on the surface of the display, or the like.

Of these techniques, the above last anti-glare treatment using the transparent resin and the transparent fine particles can diffuse external light by irregularities formed by the fine particles, or by difference in refractive index of the transparent resin and the fine particles, and an effect of extending the visible angle of the liquid crystal display may also be anticipated. Therefore, it has become the most common method at present, and is disclosed in, for example, Japanese Patent Publication No. 3314965 and Japanese Unexamined Patent Applications Publication Nos. H5-162261 and H7-181306, etc.

As an application in recent liquid crystal displays, the ratio of television has rapidly increased, and therefore, coloring development properties and color reproducibilities are regarded as more serious than previously. However, in the above anti-glare treatment using the transparent resin and the transparent fine particles, there is a problem in that unnecessary coloring occurs on an interface of the resin and the particles by reflection and refraction of light, diffraction and interference of light (such as in a rainbow and an oil film) between the fine particles, etc.

### SUMMARY OF THE INVENTION

The present invention has been made in view of the above circumstances, and it is an object thereof to provide an anti-glare film having no color alone (the above interference color is prevented) and to exhibit superior coloring development properties by removing unnecessary coloring in a display combined with a back light or liquid crystal cell.

The present inventors have conducted various research with respect to an effect in which the resin fine particles dispersed in the anti-glare layer affects optical properties in order to resolve the above problem, and consequently, they have found that transmitted spectra of the anti-glare layer differ by type, shape, or diameter of the resin fine particles, and therefore, the present invention has been attained.

That is, the anti-glare film according to the present invention includes a transparent substrate and an anti-glare layer provided on at least one surface of the transparent substrate, the anti-glare layer is formed by transparent resin which disperses at least two kinds of resin fine particles, and when a layer is formed by transparent resin which disperses each kind of the resin fine particles alone and light transmittance spectrum in a visible light region of the layer is measured, each of the light transmittance spectra is different.

In another aspect of the anti-glare film according to the present invention including a transparent substrate, an anti-glare layer and an anti-reflection layer which are provided in this order on at least one surface of the transparent substrate, the anti-glare layer is formed by transparent resin which disperses at least two kinds of resin fine particles, and when a layer is formed by transparent resin which disperses each kind of the resin fine particles alone and light transmittance spectrum in a visible light region of the layer is measured, each of the light transmittance spectra is different.

In addition, it is preferable that at least one kind of the resin fine particles in the anti-glare film be resin fine particles in a bowl shape in which the center thereof is indented so as to form a concave shape, and it is preferable that the at least two kinds of the resin fine particles be combined with different resin particles in shape.

Furthermore, it is preferable that the at least two kinds of the resin fine particles be combined with
A) resin fine particles in which transmittance is increased toward the long wavelength region in light transmittance spectra in the visible light region of a layer formed by transparent resin which disperses each kind of the resin fine particles alone, and
B) resin fine particles in which transmittance is decreased toward the long wavelength region in light transmittance spectra in the visible light region of a layer formed by transparent resin which disperses each kind of the resin fine particles alone.

According to the above anti-glare film of the present invention, the anti-glare layer is prevented from being colored by adjusting the light transmittance spectra at the visible light region (wavelength of 400 to 800 nm), and color development can be exhibited to display by compensating color tone of various optical films around the back light or liquid crystal cell.

### BRIEF DESCRIPTION OF THE DRAWINGS

FIG. 1 shows a top view of a resin fine particle in a bowl shape.

FIG. 2 shows a sectional view of a resin fine particle in a bowl shape.

FIG. 3 shows a sectional view of a resin fine particle in a flake shape.

FIG. 4 shows a sectional view of an embodiment of an anti-glare film in which an anti-glare layer which disperses resin fine particle in a bowl shape and resin fine particle in a true sphere shape to transparent resin is provided on a transparent substrate.

FIG. 5 shows a light transmittance spectrum of an anti-glare film of Example 1.

FIG. 6 shows a light transmittance spectrum of an anti-glare film of Comparative Example 1.

FIG. 7 shows a light transmittance spectrum of an anti-glare film of Comparative Example 2.

### BEST MODE FOR CARRYING OUT THE INVENTION

In the following, preferable embodiments of the present invention will be explained in detail.

The anti-glare film of the present invention is formed by dispersing at least two kinds of resin fine particles in transparent resin. The at least two kinds of resin fine particles are characterized in that each light transmittance spectra in the visible light region of a layer formed by dispersing each kind of the resin fine particles in the transparent resin alone differs.

As a transparent substrate used in the anti-glare film of the present invention, a conventional transparent film, glass, etc., can be employed. Specifically, various resin films such as polyethylene terephthalate (PET), polyethylene naphthalate (PEN), triacetyl cellulose (TAC), polymethyl methacrylate (PMMA), polycarbonate (PC), polyimide (PI), polyethylene (PE), polypropylene (PP), polyvinyl alcohol (PVA), polyvinyl chloride (PVC), cycloolefin copolymer (COC), norbornene containing resin, polyether sulfone, cellophane, aromatic polyamide, etc., and glass based materials such as fused glass, soda glass, etc., and the like, can be preferably employed. In the case in which the anti-glare film of the present invention is used for a plasma display and a liquid crystal display, it is preferable that PET, TAC, COC, norbornene containing resin, etc., be used as a transparent substance.

The higher the transparency of the transparent substrate, the better the transparent substrate. The light transmittance (Japanese Industrial Standard K-7105) is preferably 80% or more, and is more preferably 90% or more. If the light transmittance is under 80%, it is not preferable as a film for display since it is too dark.

Thickness of the transparent substrate is not limited in particular; however, the thickness is preferably 5 to 600 μm and more preferably 5 to 200 μm in consideration of the productivity thereof.

As a transparent resin used in the anti-glare film of the present invention, thermoplastic resins, thermosetting resins, radiation curable resins, etc., can be used properly. As a thermoplastic resin, various resin such as polyethylene terephthalate (PET), polyethylene naphthalate (PEN), polymethyl methacrylate (PMMA), polycarbonate (PC), polyethylene (PE), polypropylene (PP), polyvinyl alcohol (PVA), polyvinyl chloride (PVC), cycloolefin copolymer (COC), norbornene containing resin, polyether sulfone, etc., can be used.

As a thermosetting resin, phenol resin, furan resin, xylene-formaldehyde resin, ketone-formaldehyde resin, urea resin, melamine resin, aniline resin, alkyd resin, unsaturated polyester resin, epoxy resin, etc., can be employed. These may be employed alone or in combination.

As a radiation curable resin, compounds appropriately mixed with monomers, oligomers, or prepolymers having polymeric unsaturated bonds such as an acryloyl group, methacryloyl group, acryloyloxy group, methacryloyloxy group, epoxy group, vinyl ether group, oxetane group, etc., or functional groups which are similar to these, can be employed. As a monomer, methyl acrylate, methyl methacrylate, methoxy polyethylene methacrylate, cyclohexyl methacrylate, phenoxyethyl methacrylate, ethylene glycol dimethacrylate, dipentaerythritol hexaacrylate, trimethylolpropane triacrylate, etc., can be used. As an oligomer or prepolymer, acrylate compounds such as polyester acrylate, polyurethane acrylate, epoxy acrylate, polyether acrylate, alkyd acrylate, melamine acrylate, silicone acrylate, etc.; unsaturated polyester, tetramethylene glycol diglycidyl ether, propylene glycol diglycidyl ether, neopentyl glycol diglycidyl ether, bisphenol-A diglycidyl ether; epoxy-type compounds such as various alicyclic epoxies, etc.; oxetane compounds such as 3-ethyl-3-hydroxymethyl oxetane, 1,4-bis{[(3-ethyl-3-oxetanyl) methoxy]methyl}benzene, di[1-ethyl(3-oxetanyl)]methyl ether, etc.; can be used. These can be employed alone or in combination.

The higher the transparency of the transparent resin used in the anti-glare layer, the better the transparent substrate. The light transmittance (Japanese Industrial Standard K-7105) is preferably 80% or more, and is more preferably 90% or more in the same way as for the transparent substrate. If the light transmittance is under 80%, it is not preferable as a film for display since it is too dark.

As resin fine particle used in the anti-glare film of the present invention, resin fine particles of various shapes such as spherical, bowl-shaped, flake, etc., can be used. The resin fine particle which is spherical means a resin fine particle having a true sphere shape or a globular shape which is approximate to true sphere, and it can be produced by, for example, a suspension polymerization method, a spray-drying method of a polymer solution, etc.

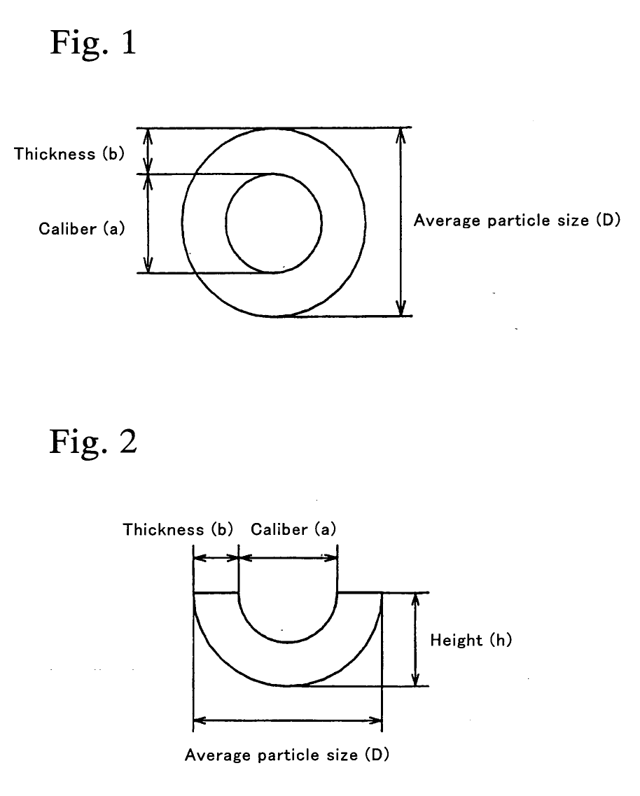

The resin fine particle in a bowl shape is not limited in particular, so long as it is resin fine particle in a bowl shape in which the center thereof is indented as in a bowl, and specifically, resin fine particles shown in FIGS. 1 and 2 in which the center thereof is indented so as to form a concave shape, can be used. FIG. 1 shows a top view of resin fine particle in a bowl shape, and FIG. 2 shows a sectional view thereof. In the present invention, it is preferable that the average particle diameter D, caliber a, thickness b and height h shown in the figures have relationships which satisfy the following expressions.
0<a<D, more preferably 0.2D<a<0.8D
0<b<0.75D, more preferably 0.1D<b<0.5D
b<h<D, more preferably 0.25D<h<0.75D

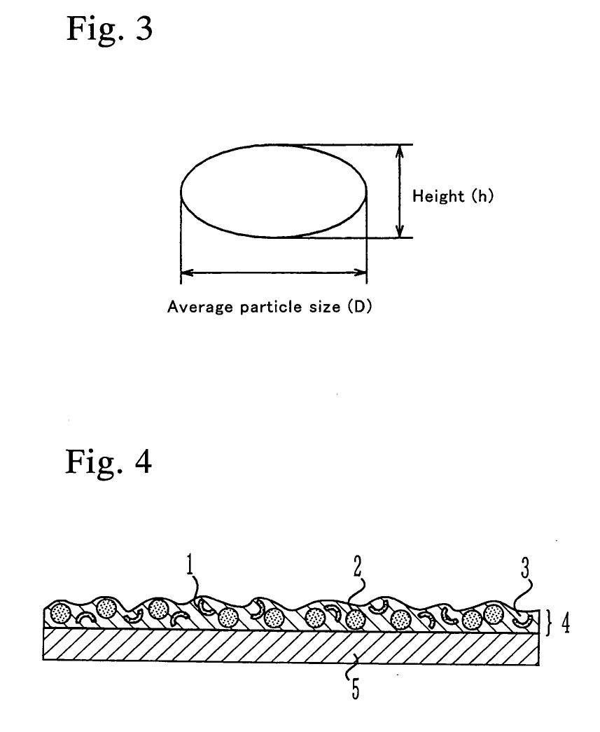

The resin fine particle in a flake shape is not limited in particular, so long as the resin fine particles have a shape which crushes the resin fine particle in a true sphere shape or the resin fine particle in a bowl shape, and specifically, it is preferable that average particle diameter D and height h shown in FIG. 3 are the relationship which satisfies the following expressions.
D/h>2,
more preferably 50>D/h>2,
most preferably 25>D/h>2

As a material for such resin fine particles, for example, acrylic resins, silicone resin, styrene resin, melamine resin, styrene-acrylic copolymer resin, etc., can be used, and they can be selected freely in consideration of the affinity with the transparent resin used in the anti-glare layer or refractive index which is different from that of the transparent resin. In addition, in order to improve dispersibility or control refractive index, the resin fine particle may be surface-treated by organic or inorganic materials such as oils and fats, silane coupling agents, metallic oxides, etc.

The refractive index of such transparent resin is not limited in particular, and it is preferable that the difference between refractive index of the material of resin fine particle and that of the transparent resin be 0.05 or more, in order to cause a certain light scattering.

Generally, in an anti-glare layer which disperses the resin fine particles in the transparent resin, light transmittance spectra differ by material, shape, or diameter of the resin fine particle, and therefore, an anti-glare layer without coloring can be produced by combining these properly. Furthermore, subtle color tones of various optical films used for liquid crystal displays such as diffusion film, brightness improvement film, polarizing plate, phase difference plate, etc., are adjusted by the anti-glare layer, and superior coloring development properties are thereby exhibited.

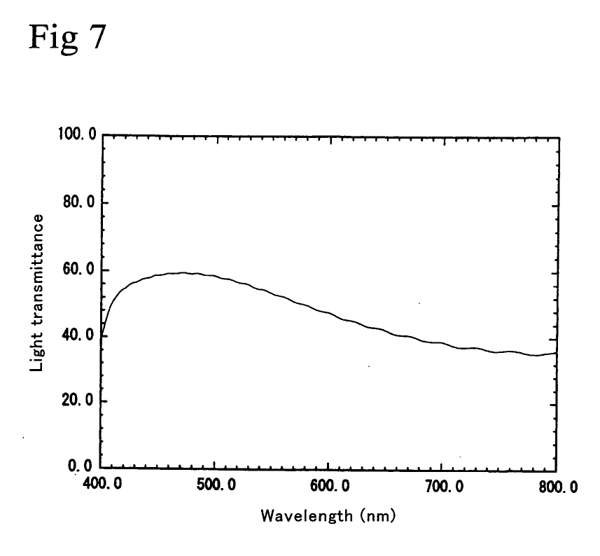

Therefore, in the anti-glare film of the present invention, at least two kinds of resin fine particles in which when a layer is formed by transparent resin which disperses each kind of the resin fine particles alone and light transmittance spectrum in a visible light region of the layer is measured, each of the light transmittance spectra is different, are combined. Here, “when a layer is formed by transparent resin which disperses each kind of the resin fine particles alone and light transmittance spectrum in a visible light region of the layer is measured, each of the light transmittance spectra is different” means for example, the relationship of spectra shown in FIGS. 6 and 7 described below. Two kinds of the resin fine particles in a bowl shape used in FIG. 6 and the resin fine particles in a true sphere shape used in FIG. 7 are combined and dispersed in the transparent resin, and an anti-glare layer in the present invention is thereby formed.

In addition, it is preferable that at least one kind of the resin fine particles be resin fine particle in a bowl shape. Furthermore, it is preferable that resin fine particles in two different shapes such as a bowl shape and a sphere shape be combined. It is preferable that in order to prevent the anti-glare film from being colored, one kind of the resin fine particles which tends to show increasing of transmittance toward the long wavelength region and the other kind of the resin fine particles which tends to show decreasing of transmittance toward the long wavelength region, in each light transmittance spectra in the visible light region of a layer formed by dispersing one kind of the resin fine particles in the transparent resin alone, be combined. Specifically, in order to show desired light transmittance spectra, these two kinds or more of the resin fine particles having different light transmittance spectrum are mixed at suitable ratio.

Average particle size of the resin fine particles used in the anti-glare film of the present invention is preferably 0.3 to 10.0 μm, and more preferably 1.0 to 7.0 μm. The size corresponds to a diameter of the resin fine particle in a sphere shape and corresponds to the major axis. When the average particle size is not more than 0.3 μm, superior light scattering cannot be obtained since it is shorter than visible light wavelength, and in contrast, when the average particle size exceeds 10.0 μm, granular shape of the resin fine particle is perceptible on the film. These values of particle size in the present invention are obtained by observing shapes thereof using an electron microscope.

Mixing ratio of the resin fine particles and the transparent resin which constitute the anti-glare layer in the present invention is not limited in particular; however, it is preferably 1/99 to 30/70 by weight ratio and more preferably 5/95 to 25/75 by weight ratio. When the mixing ratio of the resin fine particles and the transparent resin is not more than 1/99 by weight ratio, sufficient anti-glare properties cannot be obtained, and in contrast, when it exceeds 30/70 by weight ratio, the image is unclear since light scattering property is too high. Thickness of the anti-glare layer in the present invention is preferably 0.5 to 20 μm, and more preferably 1 to 10 μm. In the same way as the mixing ratio, when the thickness is not more than 0.5 μm, sufficient anti-glare properties cannot be obtained, and in contrast, when it exceeds 20 μm, the anti-glare layer is thickened unnecessarily, so as to be not economical, and in addition, the image is unclear since light scattering property is too high.

In the anti-glare film of the present invention, average roughness Ra of an irregular surface in the anti-glare layer is preferably 0.1 to 1.0 μm, and more preferably 0.1 to 0.5 μm. When the average roughness Ra is not more than 0.1 μm, an anti-glare effect in which of external light is prevented from being reflected is insufficient since the roughness of the surface is too small, and in contrast, when it exceeds 1.0 μm, the roughness is large and whitening occurs.

In the anti-glare layer in the anti-glare film of the present invention, some kinds of resin fine particles having a different shape are included, and superior anti-glare properties can be obtained by difference of refractive index of these resin fine particles and the transparent resin, and the irregularities of surface due to these resin fine particles. An embodiment of the anti-glare film of the present invention in which coating material for an anti-glare layer is prepared by dispersing resin fine particles in a bowl shape 1 and resin fine particles in a true sphere shape 2 to transparent resin 3 and an anti-glare layer 4 is provided on a transparent substrate 5 by applying the coating material, is shown in FIG. 4. Irregular shape of the surface of the anti-glare film can be control by changing size or mixing amount of each resin fine particles having a different shape.

In the anti-glare film of the present invention, an anti-reflection layer which is formed on the mostsurface of a display can be provided, in order to reduce light reflectivity on the surface of the display. That is, the anti-glare film of the present invention may be produced by laminating an anti-glare layer and an anti-reflection layer on at least one surface of a transparent substrate in this order. The anti-reflection layer can be formed by providing a low refractive index layer made of silica, etc., using a dry coating method such as vapor deposition, sputtering, etc., or by providing multi-layer films made of titania and silica, respectively, and it is preferably formed by a wet coating method since it is inexpensive and may be easily mass produced. In this case, construction A which provides one anti-reflection layer (anti-glare layer/low refractive index layer) and construction B which provides two anti-reflection layers (anti-glare layer/high refractive index layer/low refractive index layer) are typical, and it is necessary to optimize the refractive index of each layer in each construction. That is, in the construction A, final surface reflectance can be reduced by setting the refractive index of the anti-glare layer as high as possible and the refractive index of the low refractive index layer as low as possible. Here, it is preferable that the refractive index of the anti-glare layer be 1.6 or more and that the refractive index of the anti-glare layer be 1.4 or less. Furthermore, in the construction B, it is necessary to set the anti-glare layer to a medium refractive index compared to the high refractive index layer and the low refractive index layer as an anti-reflection layer. Specifically, it is preferable that the refractive index of the anti-glare layer be 1.5 to 1.6, the refractive index of the high refractive index layer be 1.65 or more, and the refractive index of the low refractive index layer be 1.4 or less.

The high refractive index layer is located between the anti-glare layer having medium refractive index and the low refractive layer which is the mostsurface of display, and generally, it has a thickness after drying of about 0.1 μm. Material of the high refractive index layer is prepared by introducing aromatic rings, halogen groups except for fluorine and sulfur, or the like, into the above resin material, or by containing ultrafine particles having high refractive index made of ZnO, TiO₂, CeO₂, etc.

In the meantime, the low refractive index layer is laminated on the anti-glare layer, or on the high refractive index layer provided on the surface of the anti-glare layer, and generally, it has a thickness after drying of about 0.1 μm. In the low refractive index layer, besides low refractive index, scratch resistance, water repellency, chemical resistance, and antifouling property are required since it is located on the mostsurface of the display. As a material of the low refractive index layer, silica prepared from hydrolysable silicon compounds and hydrolyzates thereof, or fluorine containing polymer which contains fluorine atoms on the principal chain or a side-chain of the polymer, can be used. In addition, a small amount of perfluoro alkylether compounds can be mixed in order to improve water repellency and antifouling property.

In the anti-glare layer in the present invention, if light scattering is not affected, various materials can be added as a modifier, so as to control the above refractive index, antistatic properties, coat hardness properties, and surface irregularities. In order to increase the refractive index, aromatic rings, halogen groups except for fluorine and sulfur, or the like, into transparent resin materials of the anti-glare layer, can be introduced, or ultrafine particles having high refractive index made of ZnO, TiO₂, CeO₂, ZrO₂, etc., can be contained, and in order to be antistatic, various organic conductive materials or electroconductive ultrafine particles made of ATO, ITO, ZnO—Sb₂O₅, etc., can be mixed therein. Furthermore, in order to improve the coat hardness properties, hardening components having plural cross-linkable functional groups in an identical molecule such as multifunctional acrylate, can be mixed with the transparent resin and in order to control the surface irregularities, fine particles such as silica, can be added.

Coating solution is prepared by adding and dispersing plural resin fine particles into a solution in which transparent resin is dissolved in a suitable solvent, it is coated and dried on a transparent substance, the coated film is cured, and therefore, the anti-glare film of the present invention is produced.

In order to apply the anti-glare film of the present invention to various displays, for example, a transparent substance which forms the anti-glare film of the present invention may be adhered to a visible side of deflection plates attached in both sides of LCD through an adhesion layer, so that the anti-glare layer or the anti-reflection layer on the anti-glare layer is located at the mostsurface layer of a visible side.

### EXAMPLES

In the following, the present invention will be explained in more detail by way of the Examples; however, the present invention is not limited to these.

### Example 1

100 weight parts of zirconium containing UV acrylate resin (trade name: KZ7391, solid concentration: 42%, produced by JRS Corporation) having refractive index of 1.67, as a transparent resin, and 18 weight parts of dipentaerythritol hexaacrylate having refractive index of 1.51 were mixed, so that a transparent resin solution having a refractive index after curing of 1.60 and solid concentration of 51% was prepared. 100 weight parts of the transparent resin solution, 1 weight part of 2-hydroxy-2-methylpropiophenone, as a photoinitiator, 3.6 weight parts of resin fine particle in a bowl shape (height of 1.7 μm, caliber of 1.8 μm, and thickness of 0.35 μm) made of silicone resin having a refractive index of 1.42 and average particle diameter of 2.4 μm and 5.4 weight parts of resin fine particle in a true sphere shape made of silicone resin having a refractive index of 1.42 and an average particle diameter of 2.4 μm, as a resin fine particle, and 41 weight parts of methyl isobutyl ketone, as a solvent, were added, and were dispersed for 30 minutes by a sand mill, so as to prepare a coating material. The coating material was coated on a transparent substrate made of TAC having thickness of 80 μm and permeability of 94% by a reverse coating method, and was dried for 2 minutes at 100° C. Subsequently, the coating was cured by irradiation with UV light (irradiation distance: 10 cm, irradiation time: 30 seconds) using a converging type high pressure mercury lamp of 120 W/cm, and an anti-glare film of Example 1 of the present invention with an anti-glare layer having thickness of 1.8 μm was produced.

### Comparative Example 1

An anti-glare film of Comparative Example 1 with an anti-glare layer having thickness of 1.8 μm was produced in the same manner as that in Example 1, except that two resin fine particles used in Example 1 were changed to 9 weight parts of resin fine particle in a bowl shape (height of 1.7 μm, caliber of 1.8 μm, and thickness of 0.35 μm) made of silicone resin having a refractive index of 1.42 and average particle diameter of 2.4 μm.

### Comparative Example 2

An anti-glare film of Comparative Example 2 with an anti-glare layer having a thickness of 2.0 μm was produced in the same manner as that in Example 1, except that two resin fine particles used in Example 1 were changed to 9 weight parts of resin fine particle in a true sphere shape made of silicone resin having a refractive index of 1.42 and average particle diameter of 2.4 μm.

Next, the Example and Comparative Examples were evaluated by the following methods.

Measurement of Light Transmission Spectra

With regard to the anti-glare films of Example 1 and Comparative Examples 1 and 2 as obtained above, light transmission spectra were measured at wavelengths of 400 to 800 nm by a UV-spectrophotometer (trade name: UV-3300, produced by Shimadzu Corporation).

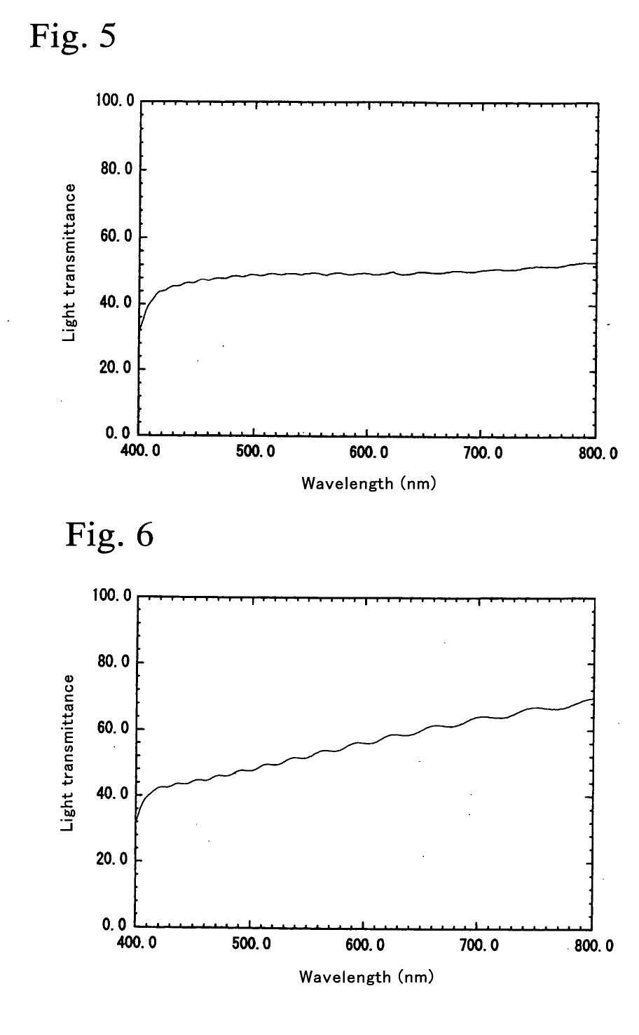

FIG. 5 shows a light transmission spectrum of the anti-glare film of Example 1 and FIGS. 6 and 7 show light transmission spectra of the anti-glare films of Comparative Examples 1 and 2.

FIG. 5 shows the light transmission spectrum for the mixture of the resin fine particles in a true sphere shape and the resin fine particles in a bowl shape, which is roughly a flat transmittance curve which has no peak in the visible light region, and therefore, it was confirmed that the anti-glare film of Example 1 was not colored. In contrast, in FIG. 6 which shows the light transmittance spectrum for the resin fine particle in a bowl shape used alone, the transmittance gradually increased toward the long wavelength region, and in FIG. 7 which shows the light transmission spectrum for the resin fine particle in a true sphere shape used alone, there was a peak within a wavelength region of 400 to 500 nm, the transmittance was gradually decreased toward the long wavelength region, and it was confirmed that unnecessary coloring was not prevented.

What is claimed is:

1. An anti-glare film comprising:
a transparent substrate, and
an anti-glare layer provided on at least one surface of the transparent substrate,
wherein the anti-glare layer is formed by transparent resin which disperses at least two kinds of resin fine particles, and
when a layer is formed by transparent resin which disperses each kind of the resin fine particles alone and light transmittance spectrum in a visible light region of the layer is measured, each of the light transmittance spectra is different.

2. An anti-glare film comprising:
a transparent substrate,
an anti-glare layer, and
an anti-reflection layer provided on at least one surface of the transparent substrate,
wherein the anti-glare layer is formed by transparent resin which disperses at least two kinds of resin fine particles, and
when a layer is formed by transparent resin which disperses each kind of the resin fine particles alone and light transmittance spectrum in a visible light region of the layer is measured, each of the light transmittance spectra is different.

3. An anti-glare film in accordance with claim 1, wherein at least one kind of the resin fine particles is resin fine particles in a bowl shape in which the center thereof is indented so as to form a concave shape.

4. An anti-glare film in accordance with claim 2, wherein at least one kind of the resin fine particles is resin fine particles in a bowl shape in which the center thereof is indented so as to form a concave shape.

5. An anti-glare film in accordance with claim 1, wherein the at least two kinds of the resin fine particles are resin particles which differ in shape.

6. An anti-glare film in accordance with claim 2, wherein the at least two kinds of the resin fine particles are resin particles which differ in shape.

7. An anti-glare film in accordance with claim 1, wherein the at least two kinds of the resin fine particles are combined with
A) resin fine particles in which transmittance is increased toward a long wavelength region in a light transmittance spectra in a visible light region of a layer formed by transparent resin which dispersing each kind of the resin fine particles alone, and
B) resin fine particles in which transmittance is decreased toward a long wavelength region in a light transmittance spectra in a visible light region of a layer formed by transparent resin which disperses each kind of the resin fine particles alone.

8. An anti-glare film in accordance with claim 2, wherein the at least two kinds of the resin fine particles are combined with
A) resin fine particles in which transmittance is increased toward a long wavelength region in a light transmittance spectra in a visible light region of a layer formed by transparent resin which disperses each kind of the resin fine particles alone, and
B) resin fine particles in which transmittance is decreased toward a long wavelength region in a light transmittance spectra in a visible light region of a layer formed by transparent resin which disperses each kind of the resin fine particles alone.
